(19) United States
(12) Patent Application Publication
(10) Pub. No.: US 2005/0123384 A1
(43) Pub. Date: Jun. 9, 2005

(54) Side-loading refuse collection and transport vehicle with combined compactor

(75) Inventor: Gabe Tomassoni, Huntsville (CA)

Correspondence Address: CONLEY ROSE, P.C., P. O. BOX 3267, HOUSTON, TX, 77253-3267, US

(73) Assignee: Fanotech Enviro Inc., Huntsville (CA)

(21) Appl. No.: 10/726,869

(22) Filed: Dec. 3, 2003

(30) Foreign Application Priority Data
Dec. 3, 2003 (CA) 2,413,470

(51) Int. Cl. B60P 1/00

(52) U.S. Cl. 414/525.2

(57) ABSTRACT

The present invention relates to a container for use in association with a transport vehicle, for collecting, compacting, storing and transporting refuse. More particularly, the invention relates to a side-loading refuse vehicle. Accordingly, the invention herein comprises a refuse collection system for use in combination with a transport vehicle. The system comprises a housing having a collection hopper at its first end, with an opening and a storage compartment at its second end. The refuse collection system also has a packing arm movable front and rearwards within the housing and having a blade portion. The packing arm is movable along a generally arcuate path from a rest position behind the collection hopper and to an extended position forward of the collection hopper. The path of travel of the blade portion passes over the collection hopper to sweep refuse from the collection hopper into the storage compartment.

### FIELD OF THE INVENTION

The present invention relates to a container for use in association with a transport vehicle, for collecting, compacting, storing and transporting refuse. More particularly, the invention relates to a side-loading refuse vehicle.

### BACKGROUND OF THE INVENTION

Side-loading refuse vehicles are well known in the art. Generally, such vehicles have a housing comprising a hopper region into which waste is deposited. The refuse is then transferred to a storage area within the housing where the refuse is compacted, to varying degrees, in order to maximize the capacity of the storage area, and thus the functional operating area of the vehicle. Once the storage area has reached its capacity, the refuse is ejected from the storage area by tilting the housing upwards or by the displacement of the refuse using a compacting blade or similar mechanism.

Examples of side-loading refuse vehicles include U.S. Pat. No. 2,750,055 (Huffines) and U.S. Pat. No. 2,961,105 (Shubin). Huffines discloses a compressor mechanism and compressor blade to move refuse to a storage compartment, while Shubin discloses a loading piston which performs the same function.

U.S. Pat. No. 4,096,956 (Gaskin) discloses a curved pusher blade, which pushes the refuse onto an inclined planar member which then pivots so as to position the refuse before a compaction blade in the storage area. As a result, refuse at the forward end of the storage area is not drawn back into the receiving area by the retraction of the compaction blade.

U.S. Pat. No. 4,260,316 (Gollnick) discloses a configuration where a hopper plate pivots about its attachment to the side of the vehicle. This transfers refuse out of the hopper into the path of a sweep panel, which in turn forces the refuse into a storage body. A packer plate then compacts the refuse within the body. This device is complicated, having a multiplicity of moving parts, and must be operated in a two-stage cycle. Furthermore, the packer plate is subject to strain since it does not span the entire width of the storage body and this also results in uneven compacting of the refuse. Finally, while the sweep panel and the packer plate are in operation, the loading opening must be closed, which compromises the safety of the operator.

U.S. Pat. No. 4,892,454 (Behling et al.) attempts to enhance the compaction capacity of the vehicle by adding a counter pressure plate that applies force opposite to a pressure plate, thus trapping the stored refuse between the two plates while compacting it.

U.S. Pat. No. 6,146,078 (Hamill et al.) discloses a packer blade that is extendible along the entire length of the storage compartment. Accordingly, an operator can add new refuse to the hopper before the packer blade has completed its refuse compaction cycle. Furthermore, a single stage hydraulic cylinder is used to achieve such extension. Channels along the length of the storage compartment, into which guides on the compactor blade and ejector mechanism fit, are necessary to ensure that the blade moves evenly. A drawback of this configuration is the likelihood of refuse blocking the channels, and thus also blocking the movement of the blade.

Finally, U.S. Pat. No. 6,250,873 (Stragier) discloses a means for ejecting and packing. Specifically, a hydraulic drive assembly is simultaneously actuated with the extension of an extendible element. Thus, during the movement of the refuse toward the storage body, the speed of the compacting plate decreases while the force exerted by the plate increases.

There are a number of limitations associated with prior art refuse collection and transport vehicles. The main drawback with these vehicles is that they disclose complicated compacting mechanisms with many moving parts. This makes such vehicles prone to failure, expensive to maintain and slow to operate. Additionally, efficient compacting of refuse is difficult to obtain since traditional compacting mechanisms do not compact to a uniform density and thus the storage capacity of the collection vehicle is not optimized.

### SUMMARY OF THE INVENTION

An object of the invention is to provide a container for use in association with a vehicle, for collecting, compacting, storing and transporting refuse.

A further object of the invention is to provide a container for use in association with a vehicle that compacts waste in a single cycle while minimizing wear upon the compacting mechanism.

A further object of the invention is to provide a container for use in association with a vehicle in which the packer blade is orientated to maximize the volume of the hopper so as to minimize the number of cycles required to transfer refuse from the hopper.

A further object of the invention is to provide a container for use in association with a vehicle having a configuration that maximizes the volume of waste within the storage area by compacting waste such that it has a uniform density throughout the storage area.

A further object of the invention is to provide a container for use in association with a vehicle with a compacting mechanism that compacts refuse efficiently without requiring tracks and guides.

A further object of the invention is to provide a container for use in association with a vehicle in which the need for a follower and other unnecessary moving parts is eliminated, thus minimizing the number of moving components in the compacting mechanism so as to limit the cost and necessity for maintenance of the vehicle while increasing its cycle speed.

Accordingly, the invention herein comprises a refuse collection system for use in combination with a transport vehicle. The system comprises a housing having a collection hopper at its first end, with an opening and a storage compartment at its second end. The refuse collection system also has a packing arm movable front and rearwards within the housing and having a blade portion. The packing arm is movable along a generally arcuate path from a rest position behind the collection hopper and to an extended position forward of the collection hopper. The path of travel of the blade portion passes over the collection hopper to sweep refuse from the collection hopper into the storage compartment.

In an alternative embodiment of the housing, the refuse collection system is attached to a transport vehicle. Furthermore, the refuse collection system disclosed herein contemplates the opening within a side wall or a top wall of the housing. In a preferred embodiment, the floor of the collection hopper is generally arcuate and closely tracks the path of the blade portion such that the blade portion has minimal clearance with the floor of the housing as the blade portion follows the generally arcuate path. In a further preferred embodiment, the width of the packing arm is equal to the width of the housing. Moreover, the packing arm preferably has an integral curved member which forms a single integral unit with the blade portion. Alternatively, a shield portion may connect the blade portion to the integral curved member so as to form a single integral unit.

In a further alternative embodiment of the refuse collection system, the blade portion has a face that is slanted such that the side of the face that engages refuse forms an angle with the floor greater than 90 degrees. Preferably, the blade face may be altered so as to vary the angle.

In a further preferred embodiment, the packing arm is pivotally suspended within the collection hopper. The packing arm is suspended by a bar that extends through the first side of the collection hopper, through an aperture in the packing arm and then through the second side of the collection hopper. Alternatively, the bar engages bearings housed by bearing housings and the bar also extends through an aperture in the packing arm.

In a further embodiment of the refuse collection system, the storage compartment is divided into two or more sub-compartments and the size of the sub-compartments may be varied.

### BRIEF DESCRIPTION OF THE DRAWINGS

These and other advantages of the invention will become apparent upon reading the following detailed description and upon referring to the drawings in which:

FIG. 1 is a side plan view of the container attached to a vehicle for collecting waste in which the housing has been partially cut away so as to show the packing mechanism;

FIG. 2 is a side plan view of the container attached to a vehicle for collecting waste in which the packing mechanism is in the rest position and waste is in the hopper;

FIG. 3 is a side plan view of the container attached to a vehicle for collecting waste in which the packing mechanism is in the deposit position and the waste has been transferred into the hopper;

FIG. 4 is a side plan view of the packing mechanism of the invention disclosed in FIG. 1 in the rest position;

FIG. 5 is a side plan view of the packing mechanism of the invention disclosed in FIG. 1 in the deposit position;

FIG. 6 is a top plan view of the dual hydraulic press mechanism of the invention disclosed in FIG. 1 in the rest position and in the deposit position; and

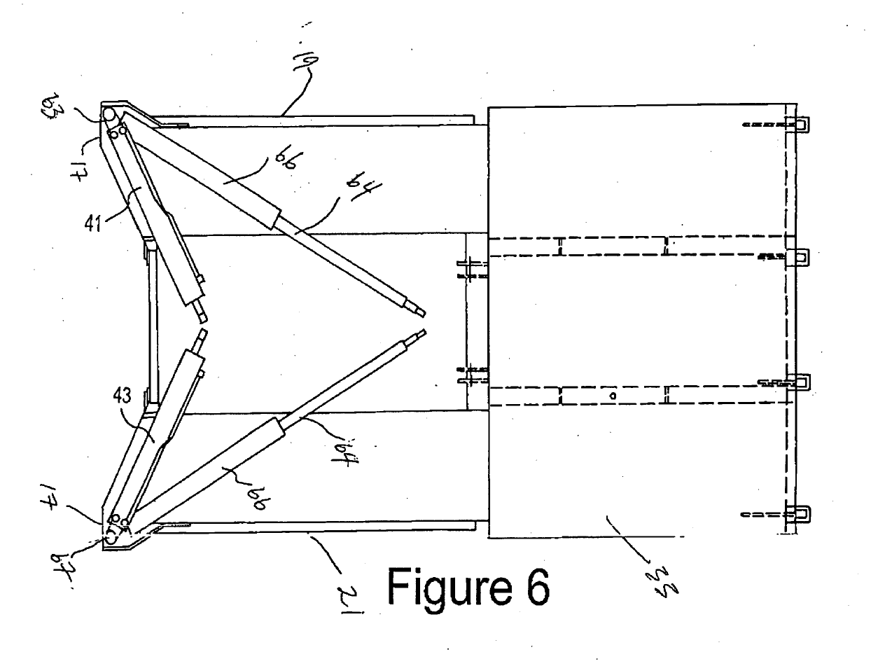

FIG. 7 is a side plan view of the container attached to a vehicle for collecting waste in which the door is in an open position and the housing in an eject position.

While the invention will be described in conjunction with the illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE INVENTION

In the following description, similar features in the drawings have been given similar reference numerals.

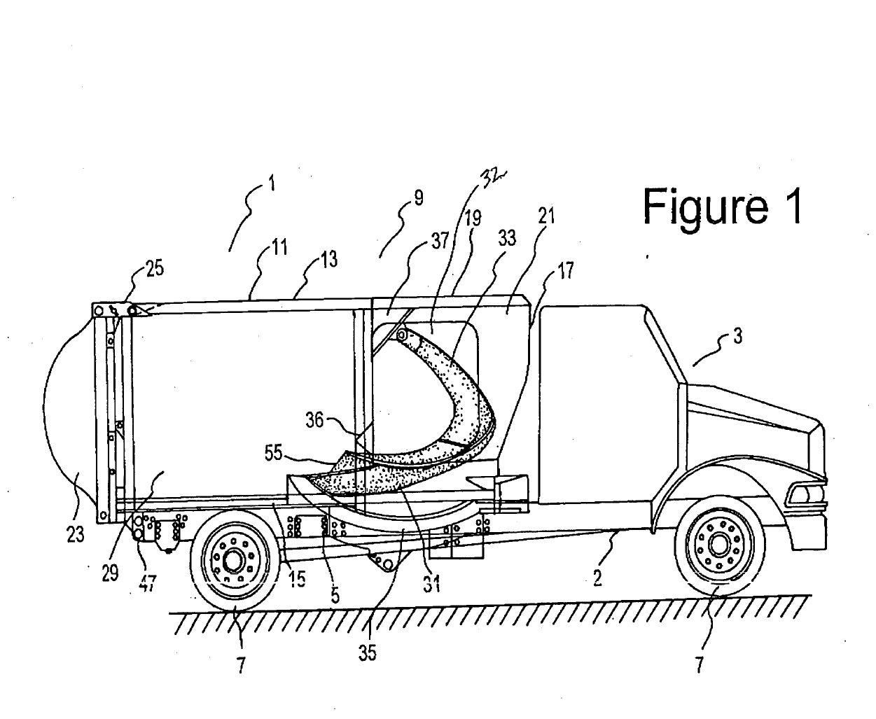

A container for collecting, compacting and storing refuse 1, for use in association with a vehicle 2, having a cab 3, chassis 5 and wheels 7 is shown in FIG. 1. A housing 11 comprising a top wall 13, a floor portion 15, a front wall 17, a first side wall 19 and a second side wall 21 is mounted on the chassis 5 of the vehicle 2. A door 23 is pivotally attached to the housing 11 by a pivoting attachment means 25. The container for collecting, compacting and storing refuse 1 is attached to the vehicle 2 by an attachment means 47.

A refuse storage area 29 is located in the rear portion of the housing 11 and a hopper portion 31 is located towards the forward portion of the housing 11. In a preferred embodiment, the hopper portion 31 has a loading opening 32, a curved floor 35 and a breaker bar 36. The loading opening 32 may be in the first side wall 19, the second side wall 21 or the top wall 13. The breaker bar 36 is preferably positioned near a border between hopper portion 31 and storage area 29. A compacting mechanism 33 is preferably pivotally attached near the top wall 13 of the housing 11.

The door 23 is shaped so as to fit within the opening defined by the top wall 13, the floor portion 15, the first side wall 19 and the second side wall 21 in a closed position.

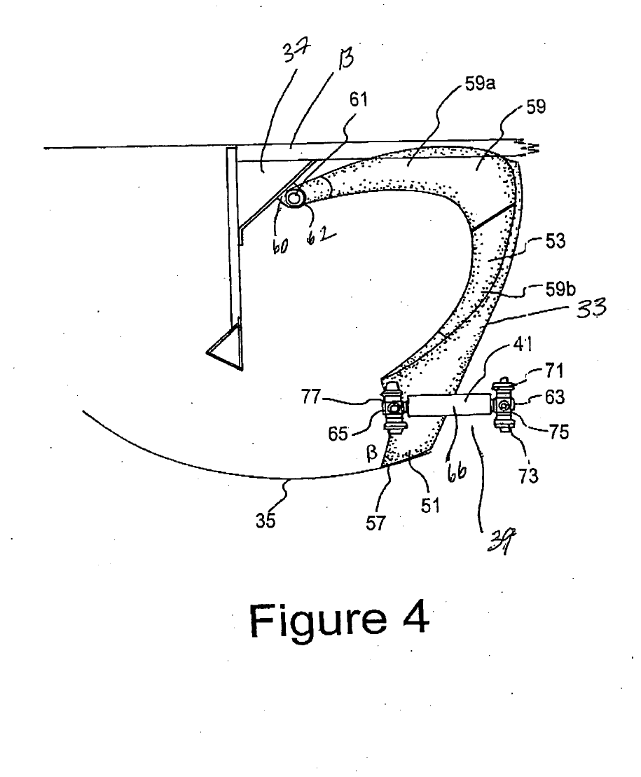

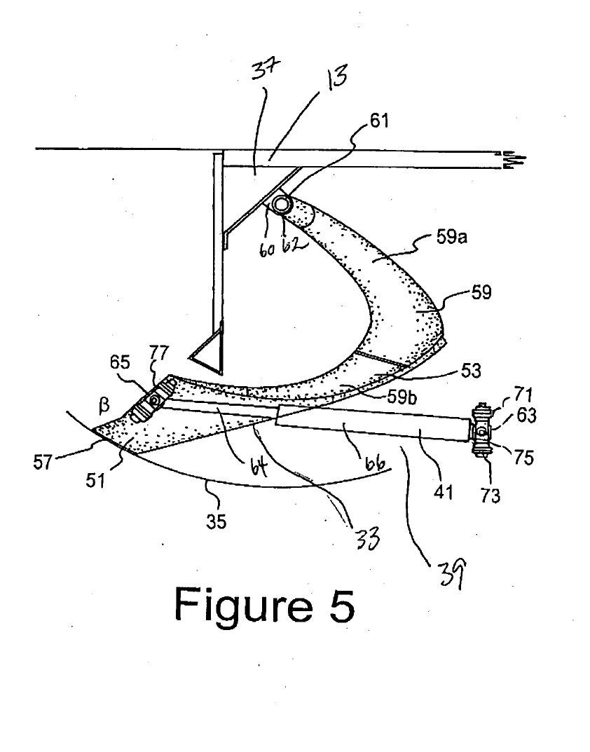

Referring to FIGS. 4 and 5, the compacting mechanism 33 comprises a blade 51, a shield 53 and an integral curved member 59. The shield 53 attaches the blade 51 to the integral curved member 59. The blade 51 has a face 55 and a bottom edge 57. In a preferred embodiment, the width of face 55 is preferably equal to the width of the hopper 31. Preferably, an angle β, formed by the side of the face 55 that engages refuse and the curved floor 35, is greater than 90°. In a preferred embodiment, the operator may alter the positioning of face 55 and thus the angle P. The bottom edge 57 has minimal clearance with the curved floor 35 of hopper 31. Preferably, the shield 53 also has a width that extends across the entire width of the hopper 31.

The compacting mechanism 33 is mounted within the hopper 31 by suspending the integral curved member 59 from the top wall 13. A first end of the integral curved member 59 is preferably pivotally attached to an overhang 37 which is connected to the top wall 13. Bearing housings 60 and 62 are attached to the overhang 37 or alternatively are attached directly to the top wall 13. Bearing housings 60 and 62 each house a bearing (not shown). The pivotal attachment of the integral curved member 59 may be achieved by passing a bar 61 through an aperture in the integral curved member 59. Each end of the bar 61 engages one of the bearings within the bearing housings 60 and 62 such that the compacting mechanism is suspended from the top wall 13.

The integral curved member 59 consists of a first portion 59a which is generally orientated against the top wall 13 of the housing 11 when the compacting mechanism 33 is in a rest position and a second portion 59b which is preferably integrally attached along its length to the shield 53 and is orientated in a generally parallel manner with the front wall 17 when compacting mechanism 33 is in a rest position. Thus, integral curved member 59 is generally “C-shaped” as best seen in FIG. 4.

An hydraulic press mechanism 39 preferably consists of a first hydraulic cylinder 41, a second hydraulic cylinder 43, and brackets 63, 65, 67 and 69. Each of the first hydraulic cylinder 41 and the second hydraulic cylinder 43 has a ram portion 64 and a cylinder portion 66. The cylinder portion 66 of the first hydraulic cylinder 41 is preferably attached to the bracket 63, which in turn is preferably attached at the intersection of front wall 17 and first side wall 19. The ram portion 64 of the first hydraulic cylinder 41 is preferably attached to the bracket 65 which is in turn attached to the blade 51 of the compacting mechanism 33. The cylinder portion 66 of the second hydraulic cylinder 43 is preferably attached to the bracket 67, which in turn is preferably attached to the intersection of the front wall 17 and the second side wall 21. The ram portion 64 of the second hydraulic cylinder 43 is preferably attached to the bracket 69, which in turn is attached to the blade 51 of the compacting mechanism 33.

The structure of the brackets will be described with reference to the brackets 63 and the bracket 65. The bracket 63 has a first bracket end 71 and a second bracket end 73. The bracket end 71 and the bracket end 73 are removably attachable to a surface for supporting the bracket 63. A bridge 75 joins the first bracket end 71 and the second bracket end 73 and receives the cylinder portion of the first hydraulic cylinder 41. The cylinder portion 66 of the first hydraulic cylinder 41 engages the bridge 75 while the ram portion 64 of the first hydraulic cylinder 41 engages a bridge 77 of the bracket 65. Preferably, the first hydraulic cylinder 41 is pivotally attached to the bracket 63 and the bracket 65.

In an alternative embodiment of the invention, the storage area 29 is divided into multiple compartments for the storage of different types of refuse. In this embodiment, different types of refuse can be segregated within the hopper 31. Preferably, the compacting mechanism 33 is adapted to displace the different types of refuse into their respective compartments in storage area 29. Additionally, the position of the barrier separating the multiple compartments in the storage area 29 may be altered to account for different volumes of refuse.

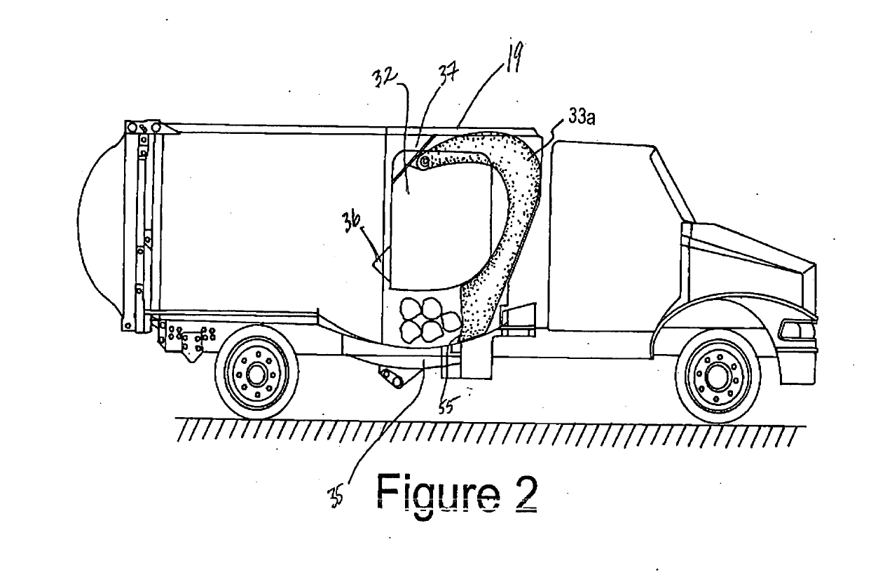

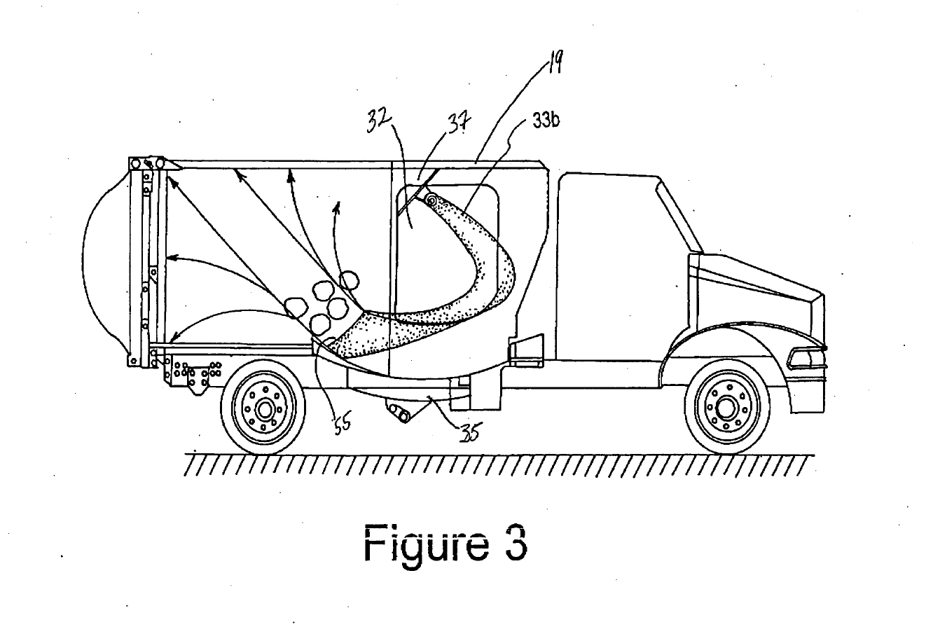

In operation, to move refuse received through loading opening 32 from the hopper 31 to the storage area 29, the first hydraulic cylinder 41 and the second hydraulic cylinder 43 extend to force the blade 51 along the curved floor 35 and pivot the compacting mechanism 33 about the longitudinal axis of the bar 61. As seen in FIGS. 2 and 3, as the compacting mechanism 33 advances through hopper 31 along a generally arcuate path, the bottom edge 57 of the blade 51 has minimal clearance with the curved floor 35 such that refuse along the width of the hopper 31 is collected against the face 55 of the blade 51. Thus, the compacting mechanism 33 is activated such that the integral curved member 59 swings about the longitudinal axis of the bar 61 so as to displace the compacting mechanism 33 from a rest position 33a to a deposit position 33b. While the compacting mechanism 33 is displaced from the rest position 33a to the deposit position 33b, the path of the compacting mechanism 33 and thus the bottom edge 57 of the blade 51 closely tracks the curved floor 35.

The movement of the compacting mechanism 33 between the rest position 33a and the deposit position 33b is occasioned by the extension or retraction of the dual hydraulic press mechanism 39. As the compacting mechanism 33 displaces the refuse, the shield 53 prevents refuse from contacting the dual hydraulic press mechanism 39. When the first hydraulic cylinder 41 and the second hydraulic cylinder 43 are fully extended, and the compacting mechanism 33 is in the deposit position 33b, the blade 51 is at or near the border of the storage area 29 and the hopper 31.

As seen in FIGS. 4 and 5, the engagement of the first hydraulic cylinder 41 with the bracket 63 and the bracket 65 accommodates the displacement of the compacting mechanism 33 along a generally arcuate path within the hopper 31. Furthermore, the second hydraulic cylinder 43 extends and retracts in tandem with the first hydraulic cylinder 41 and engages the bracket 67 and the bracket 69 in the same manner as the first hydraulic cylinder 41 engages the bracket 63 and the bracket 65. The operation of the compacting mechanism 33 in combination with the orientation of the blade 51 propels refuse inwards and upwards, thus tending to fill and compact the entire volume of the storage compartment.

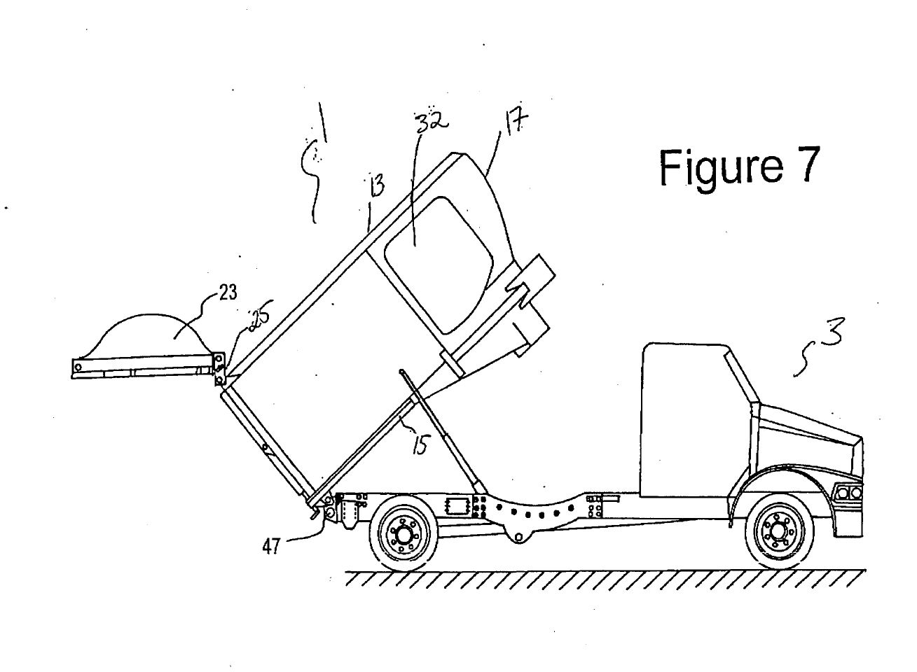

After numerous cycles of the compacting mechanism 33 within the hopper 31, it will be necessary to eject refuse from the storage area 29. This is achieved by the movement of the housing 11 about a pivoting attachment means 25. As seen in FIG. 7, the door 23 is swung into its open position and the housing 11 is elevated from its position on the chassis 5 by elevation means and rotates about the attachment means 47.

Numerous modifications may be made to the embodiments as described above without departing from the scope of the invention, which is defined by the claims.

Thus, it is apparent that there has been provided in accordance with the invention a SIDE-LOADING REFUSE COLLECTION AND TRANSPORT VEHICLE WITH COMBINED COMPACTOR that fully satisfies the objects, aims and advantages set forth above. While the invention has been described in conjunction with specific embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

1. A refuse collection system for use in combination with a transport vehicle, said system comprising:
a housing having a collection hopper at its first end, with an opening, and a storage compartment at its second end;
a packing arm movable front and rearwards within said housing and having a blade portion, said packing arm being movable along a generally arcuate path from a rest position behind said collection hopper and to an extended position forward of said collection hopper, the path of travel of said blade portion passing over said collection hopper to sweep refuse from the collection hopper into the storage compartment.

2. The refuse collection system of claim 1 wherein the housing is attached to a transport vehicle.

3. The refuse collection system of claim 1 wherein the opening is in the side of the housing.

4. The refuse collection system of claim 1 wherein the opening is in the top of the housing.

5. The refuse collection system of claim 1 wherein the collection hopper has a generally arcuate floor that closely tracks the path of the blade portion.

6. The refuse collection system of claim 1 wherein the width of the packing arm is equal to the width of the housing.

7. The refuse collection system of claim 1 wherein the packing arm has an integral curved member.

8. The refuse collection system of claim 1 wherein the blade portion has minimal clearance with the floor of the housing at the rest position and closely tracks the floor of the housing as the packing arm moves along the generally arcuate path through to its extended position.

9. The refuse collection system of claim 7 wherein the blade portion and the integral curved member form a single integral unit.

10. The refuse collection system of claim 7 wherein a shield portion connects the blade portion to the integral curved member.

11. The refuse collection system of claim 10 wherein the blade portion, the integral curved member and the shield portion are formed into a single integral unit.

12. The refuse collection system of claim 1 wherein the blade portion has a face that is slanted such that an angle between the side of the blade face that engages refuse and the floor of the collection hopper is greater than 90 degrees.

13. The refuse collection system of claim 12 wherein the blade face can be altered so as to vary the angle between the blade face and the floor of the collection hopper.

14. The refuse collection system of claim 1 wherein the packing arm is pivotally suspended within the collection hopper.

15. The refuse collection system of claim 14 wherein the packing arm is pivotally suspended by a bar that extends through the first side of the collection hopper, through an aperture in the packing arm and then through the second side of the collection hopper.

16. The refuse collection system of claim 14 wherein bearing housings are attached to the top of the collection hopper and the packing arm is pivotally suspended by a bar that engages bearings within the bearing housings and the bar extends from a first bearing housing, through an aperture in the packing arm and then to a second bearing housing.

17. The refuse collection system of claim 1 wherein the storage compartment is divided into two or more sub-compartments.

18. The refuse collection system of claim 17 wherein the size of the sub-compartments may be varied.
